(19) United States
(12) Patent Application Publication
(10) Pub. No.: US 2016/0072276 A1
(43) Pub. Date: Mar. 10, 2016

(54) OVERVOLTAGE PROTECTION CIRCUIT

(71) Applicants: HONG FU JIN PRECISION INDUSTRY (WuHan) CO. LTD., Wuhan (CN); HON HAI PRECISION INDUSTRY CO., LTD., New Taipei (TW)

(72) Inventor: PENG ZHANG, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/550,568

(22) Filed: Nov. 21, 2014

(30) Foreign Application Priority Data
Sep. 9, 2014 (CN) 201410454709.9

(51) Int. Cl. H02H 7/125; H02M 7/06

(52) U.S. Cl. CPC H02H 7/1252; H02M 7/066

(57) ABSTRACT

An overvoltage protection circuit includes a supplying power circuit, a triggering circuit, and a controlling circuit. The supplying power circuit coverts AC power into DC power. The supplying power circuit includes a voltage detective point. The triggering circuit is connected to the voltage detective point. The triggering circuit is triggered when the voltage detective point in a high level voltage. The controlling circuit is connected to the triggering circuit. The controlling circuit includes a power supply point. The controlling circuit cuts off the power supply point when the triggering circuit is triggered.

### CROSS-REFERENCE TO RELATED APPLICATIONS

This application claims priority to Chinese Patent Application No. 201410454709.9 filed on Sep. 9, 2014, the contents of which are incorporated by reference herein.

### FIELD

The subject matter herein generally relates to protection circuit, and particularly to an overvoltage protection circuit.

### BACKGROUND

Electronic devices, such as computers, are provided with one or more voltages. If the voltages are not stable, electronic elements in the electronic devices would be damaged especially when the voltages rises quickly and largely.

### BRIEF DESCRIPTION OF THE DRAWINGS

Implementations of the present technology will now be described, by way of example only, with reference to the attached figures.

FIG. 1 is a block diagram of one embodiment of an overvoltage protection circuit.

FIG. 2 is a circuit diagram of one embodiment of the overvoltage protection circuit of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

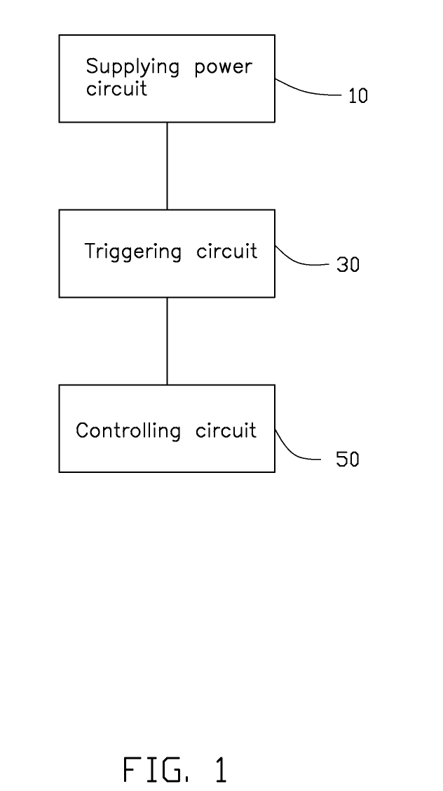

FIG. 1 illustrates one embodiment of an overvoltage protection circuit. The overvoltage protection circuit includes a supplying power circuit 10, a triggering circuit 30, and a controlling circuit 50. The supplying power circuit 10 is connected to the triggering circuit 30, and the controlling circuit 50 is connected to the triggering circuit 30.

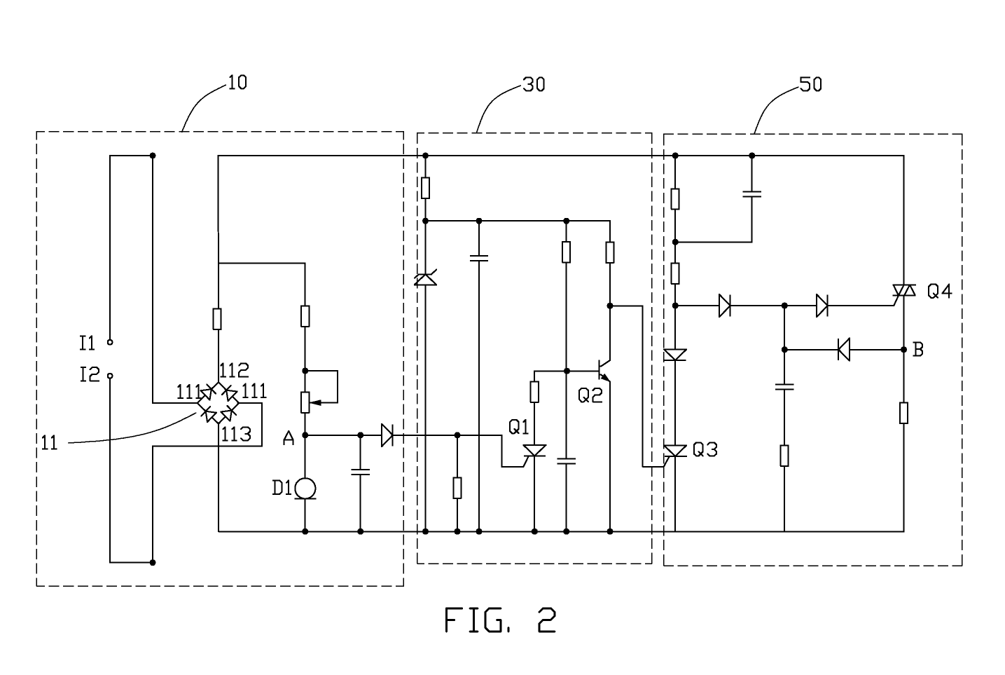

Referring to FIG. 2, the supplying power circuit 10 includes two AC (alternating current) terminals I1 and 12, a bridge rectifier circuit 11, and a constant current diode D1. The AC terminals I1 and 12 are used to connect a AC power. The bridge rectifier circuit 11 includes two input ends 111, a positive output end 112, and a negative output end 113. The two input ends 111 are connected to the two AC terminals I1 and 12. The constant current diode D1 and resistors (not labeled) are connected between the positive output end 112 and the negative output end 113. A voltage detective point A is set between the constant current diode D1 and the resistor.

The triggering circuit 30 includes a first unidirectional thyristor Q1 and a NPN type transistor Q2. The base terminal of the transistor Q2 is connected to the positive output end 112 via resistors, and further connected to the positive terminal of the first unidirectional thyristor Q1. The negative terminal of the first unidirectional thyristor Q1 is connected to the negative output end 113. The control terminal of the first unidirectional thyristor Q1 is connected to the voltage detective point A. The collector terminal of the transistor Q2 is also connected to the positive output end 112 via resistors. The emitter terminal of the transistor Q2 is connected to the negative output end 113.

The controlling circuit 50 includes a second unidirectional thyristor Q3 and a bidirectional thyristor Q4. The control terminal of the second unidirectional thyristor Q3 is connected to the collector terminal of the transistor Q2. The positive terminal of the second unidirectional thyristor Q3 is connected to the positive output end 112 via resistors, and further connected to the control terminal of the bidirectional thyristor Q4. The negative terminal of the second unidirectional thyristor Q3 is connected to the negative output end 113. Opposite terminals of the bidirectional thyristor Q4 are connected between the positive output end 112 and the negative output end 113. A power supply point B is set between the bidirectional thyristor Q4 and the negative output end 113.

When the AC power provided on the two AC terminals I1 and 12 are normal and stable, a low level voltage is generated on the voltage detective point A. The first unidirectional thyristor Q1 is turned off, and the transistor Q2 is turned on because the base terminal of the transistor Q2 is not connected to the negative output end 113 via the first unidirectional thyristor. The second unidirectional thyristor Q3 is turned off. Then, the control terminal of the bidirectional thyristor Q4 is in a high level voltage to turn on the bidirectional thyristor Q4. Therefore, the power supply point B supplies power normally.

When the AC power provided on the two AC terminals I1 and 12 rises, a high level voltage is generated on the voltage detective point A. The first unidirectional thyristor Q1 is turned on, and the transistor Q2 is turned off because the base terminal of the transistor Q2 is connected to the negative output end 113 via the first unidirectional thyristor. The second unidirectional thyristor Q3 is turned on. Then, the control terminal of the bidirectional thyristor Q4 is in a low level voltage to turn off the bidirectional thyristor Q4. Therefore, the power supply point B does not supply power.

In the overvoltage protection circuit, the voltage detective point A detects voltage, and turns off the bidirectional thyristor Q4 to cutoff the power supplying from the power supply point B when the voltage is high. Therefore, power consumption components supplied by the power supply point B is protected.

The embodiments shown and described above are only examples. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to, and including, the full extent established by the broad general meaning of the terms used in the claims. It will therefore be appreciated that the embodiments described above may be modified within the scope of the claims.

What is claimed is:

1. An overvoltage protection circuit comprising:
a supplying power circuit configured to covert AC power into DC power, the supplying power circuit comprising a voltage detective point;
a triggering circuit connected to the voltage detective point, the triggering circuit configured to be triggered when the voltage detective point receives a high level voltage; and
a controlling circuit connected to the triggering circuit, the controlling circuit comprising a power supply point, and the controlling circuit configured to deactivate the power supply point when the triggering circuit is triggered.

2. The overvoltage protection circuit of claim 1, wherein the supplying power circuit comprises a bridge rectifier circuit, the bridge rectifier circuit comprising a positive output end and a negative output end, the voltage detective point is between the positive output end and the negative output end.

3. The overvoltage protection circuit of claim 1, wherein the triggering circuit comprises a first unidirectional thyristor and a transistor, a control terminal of the first unidirectional thyristor is connected to the voltage detective point, a positive terminal of the first unidirectional thyristor is connected to the positive output end and a base terminal of the transistor, an emitter terminal of the transistor is connected to the negative output end, and a collector terminal of the transistor is connected to the positive output end.

4. The overvoltage protection circuit of claim 3, wherein the controlling circuit comprises a second unidirectional thyristor, a control terminal of the second unidirectional thyristor is connected to the collector terminal of the transistor, a positive terminal of the second unidirectional thyristor is connected to the positive output end, and a negative terminal of the second unidirectional thyristor is connected to the negative output end.

5. The overvoltage protection circuit of claim 4, wherein the controlling circuit further comprises a bidirectional thyristor, opposite terminals of the bidirectional thyristor are connected between the positive output end and the negative output end, and a controlling terminal of the bidirectional thyristor is connected to the positive terminal of the second unidirectional thyristor.

6. The overvoltage protection circuit of claim 5, wherein the power supply point is set between the bidirectional thyristor and the negative output end.

7. The overvoltage protection circuit of claim 2, wherein the bridge rectifier circuit comprises two input ends for receiving an AC power.

8. The overvoltage protection circuit of claim 2, wherein a constant current diode is connected between the voltage detective point and the negative output end.

9. An overvoltage protection circuit, comprising:
a supplying power circuit configured to supplying power to a plurality of power consumption components;
a triggering circuit connected to the voltage detective point, the triggering circuit configured to be triggered when an outputted voltage of the supplying power circuit rises; and
a controlling circuit connected to the triggering circuit, and the controlling circuit configured to deactive the supplying power circuit and the plurality of power consumption components when the triggering circuit is triggered.

10. The overvoltage protection circuit of claim 9, wherein the supplying power circuit comprising a voltage detective point, and the triggering circuit is configured to be triggered when the voltage detective point receives a high level voltage.

11. The overvoltage protection circuit of claim 10, wherein the supplying power circuit comprises a bridge rectifier circuit, the bridge rectifier circuit comprising a positive output end and a negative output end, the voltage detective point is between the positive output end and the negative output end.

12. The overvoltage protection circuit of claim 10, wherein the triggering circuit comprises a first unidirectional thyristor and a transistor, a control terminal of the first unidirectional thyristor is connected to the voltage detective point, a positive terminal of the first unidirectional thyristor is connected to the positive output end and a base terminal of the transistor, an emitter terminal of the transistor is connected to the negative output end, and a collector terminal of the transistor is connected to the positive output end.

13. The overvoltage protection circuit of claim 12, wherein the controlling circuit comprises a second unidirectional thyristor, a control terminal of the second unidirectional thyristor is connected to the collector terminal of the transistor, a positive terminal of the second unidirectional thyristor is connected to the positive output end, and a negative terminal of the second unidirectional thyristor is connected to the negative output end.

14. The overvoltage protection circuit of claim 13, wherein the controlling circuit further comprises a bidirectional thyristor, opposite terminals of the bidirectional thyristor are connected between the positive output end and the negative output end, and a controlling terminal of the bidirectional thyristor is connected to the positive terminal of the second unidirectional thyristor.

15. The overvoltage protection circuit of claim 14, wherein the power supply point is set between the bidirectional thyristor and the negative output end.

16. The overvoltage protection circuit of claim 11, wherein the bridge rectifier circuit comprises two input ends for receiving an AC power.

17. The overvoltage protection circuit of claim 11, wherein a constant current diode is connected between the voltage detective point and the negative output end.
